(19) United States
(12) Patent Application Publication
(10) Pub. No.: US 2009/0047531 A1
(43) Pub. Date: Feb. 19, 2009

(54) PACKAGES HAVING RADIATION-CURABLE COATINGS

(75) Inventors: Michael Bartley, Loveland, OH (US); Mark Bowman, New Kensington, PA (US); James A. Claar, Apollo, PA (US); Mark Martin, Milford, OH (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/840,467

(22) Filed: Aug. 17, 2007

(51) Int. Cl. B32B 23/08; B05D 3/06; C08F 120/04

(52) U.S. Cl. 428/515; 106/287.24; 427/487

(57) ABSTRACT

A package coated at least in part with a composition comprising a) a poleyne and b) a polythiol, wherein the composition is curable by radiation, is disclosed. Methods for making such a package are also disclosed.

### FIELD OF THE INVENTION

The present invention relates to packages coated at least in part with a composition comprising a polyene and a polythiol, wherein the composition is curable by radiation.

### BACKGROUND OF THE INVENTION

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This is particularly true when the contents of the can are acidic in nature, such as tomato-based products and soft drinks. The coatings applied to the interior of metal cans also helps prevent corrosion in the head space of the cans, which is the area between the fill line of the product and the can lid; corrosion in the head space is particularly problematic with food products having a high salt content.

Coatings can also be applied to the exterior of metal cans, again, to provide corrosion resistance, and/or also to provide ease in manufacture. Such coatings can include, for example, various lubricant products including a rim coat that is applied to the bottom rim of the can to reduce friction during handling. A wash coat can be applied externally to protect the can from corrosion. Various base coats, size coats, inks, overvarnishes, and the like can be used to provide decoration and/or other information regarding the contents of the package, and/or to facilitate protection and/or application of printing inks. Certain coatings are particularly applicable for use with coiled metal stock, such as the coiled metal stock from which the ends of cans are made (“can end stock”), and caps and closures are made (“cap/closure stock”). Since coatings designed for use on can end stock and cap/closure stock are typically applied prior to the piece being cut and stamped out of the coiled metal stock, they are typically flexible and extensible. For example, such stock is typically coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy-open” can ends. For easy-open can ends, a score substantially around the perimeter of the lid allows for easy opening or removing of the lid from the can, typically by means of a pull tab. For caps and closures, the cap/closure stock is typically coated, such as by roll coating, and the cap or closure stamped out of the stock; it is possible, however, to coat the cap/closure after formation. Coatings for cans subjected to relatively stringent temperature and/or pressure requirements should also be resistant to “popping”, “blushing” and/or “blistering”.

Coatings can also be applied to packages made from polymeric substrates, such as plastics. Plastics have found increasing use as replacements for glass and metal containers in packaging, especially of foods and beverages. One of the common polymeric packaging materials used today by the food and beverage industry is poly(ethyleneterephthalate) (“PET”). Notwithstanding its widespread use, PET has a relatively high oxygen permeability constant, which is a measure of the amount of oxygen that can pass through a film or coating under a specific set of circumstances. Thus, while coatings can be applied to polymeric substrates to provide decoration and/or other information regarding the contents of the package, they can also be applied to provide barrier protection to inhibit the ingress and/or egress of various gases. For example, some oxygen-sensitive products may become discolored and/or spoiled upon even minute exposures to oxygen, and carbonated beverages can lose their carbonation or become “flat” if carbon dioxide is removed. Coatings can also be applied to polymeric substrates as a varnish, and/or as an adhesive for subsequent coating layers and/or for a label, and can also be used between layers of a laminate.

In addition to the protection they provide, coatings for packages, particularly those for food, beverage, and personal care items, should be non-toxic, and should not adversely affect the taste of the items, such as food, beverage, toothpaste, and the like in the package.

### SUMMARY OF THE INVENTION

The present invention is directed to a package coated at least in part with a composition comprising a) a polyene and b) a polythiol, wherein the composition is curable by radiation. Methods for making such packages are also disclosed.

### DETAILED DESCRIPTION OF THE INVENTION

The present invention is directed to a package coated at least in part with a composition comprising a) a polyene and b) a polythiol, wherein the composition is curable by radiation. Suitable polyenes for use in the present invention are numerous and can vary widely. Such polyenes can include those that are known in the art. Suitable polyenes can comprise those that are represented by the formula:

A-(X)ₘ
wherein A is an organic moiety, X is an olefinically unsaturated moiety and m is at least 2, such as 2 to 4. Examples of X are groups of the following structures:

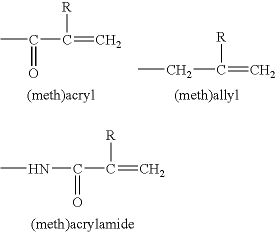

wherein each R is H or methyl.

The polyenes may be compounds or polymers having in the molecule olefinic double bonds that are polymerizable by exposure to radiation. Examples of such materials are (meth)acrylates, which includes any compound having the (meth)acryl group shown above, such as (meth)acrylic functional (meth)acrylic copolymers, epoxy resin (meth)acrylates, polyester (meth)acrylates, polyether (meth)acrylates, phosphate (meth)acrylates, polyurethane (meth)acrylates, amino(meth)acrylates, silicone (meth)acrylates, and/or melamine(meth)acrylates. The number average molar mass (Mn) of these compounds can be 200 to 10,000. The polyene can contain on average 2 to 20 olefinic double bonds that are polymerizable by exposure to radiation. Aliphatic and/or cycloaliphatic (meth)acrylates in each case are particularly suitable.

(Cyclo)aliphatic polyurethane (meth)acrylates and (cyclo)aliphatic polyester (meth)acrylates are also particularly suitable. Specific examples of polyurethane (meth)acrylates include, without limitation, the 1:2 molar ratio reaction products of 1,6-hexamethylene diisocyanate and/or isophorone diisocyanate with hydroxyethyl (meth)acrylate and/or hydroxypropyl (meth)acrylate. Examples of polyester (meth)acrylates include, without limitation, glycerol tri(meth)acrylate, trimethylolpropane tri(meth)acrylate, pentaerythritol tri(meth)acrylate and pentaerythritol tetra(meth)acrylate.

As noted above, the polyene can comprise a (meth)allyl compound. Examples of (meth)allyl compounds are polyurethanes and polyesters containing (meth)allyl groups, such as the 1,2-molar reaction products of 1,6-hexamethylene diisocyanate and/or isophorone diisocyanate with the diallylether of trimethylolpropane. Mixtures of polyenes can also be used. In some embodiments, the mixture comprises urethane (meth)acrylate and (meth)acrylate. (Meth)acrylate and (meth)allyl can also be used together. As used herein and as is conventional in the art, (meth)acrylate and like terms refer to both acrylate and the corresponding methacrylate, (meth)allyl and like terms to both allyl and the corresponding methallyl, and (cyclo)aliphatic to both aliphatic and the corresponding cycloaliphatic.

Suitable polythiols for use in the present invention are also numerous and can vary widely. Such polythiols can include those that are known in the art. As used herein, “polythiol”, “polythiol functional material” and like terms refer to polyfunctional materials containing two or more thiol functional groups (SH). Examples of suitable polythiol functional materials can include, but are not limited to, polythiols having ether linkages (—O—), sulfide linkages (—S—), including polysulfide linkages (—Sₓ—), wherein x is at least 2, such as from 2 to 4, and combinations of such linkages.

Other suitable polythiols for use in the present invention include, but are not limited to, materials of the formula:

R₁—(SH)ₙ

wherein R₁ is a polyvalent organic moiety and n is at least 2, such as 2 to 6.

Other examples of suitable polythiols include, but are not limited to, esters of thiol-containing acids of the formula:

HS—R₂—COOH

wherein R₂ is an organic moiety reacted with a polyhydroxy compound of the structure R₃—(OH)ₙ wherein R₃ is an organic moiety and n is at least 2, such as 2 to 6. These components can be reacted under suitable conditions to give polythiols having the general structure:

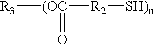

wherein R₂, R₃ and n are as defined above.

Examples of thiol-containing acids are thioglycolic acid (HS—CH₂COOH), α-mercaptopropionic acid (HS—CH(CH₃)—COOH) and β-mercaptopropionic acid (HS—CH₂CH₂COOH) with polyhydroxy compounds such as glycols, triols, tetraols, pentaols, hexaols, and mixtures thereof. Other non-limiting examples of suitable polythiols include, but are not limited to, ethylene glycol bis(thioglycolate), ethylene glycol bis(β-mercaptopropionate), trimethylolpropane tris(thioglycolate), trimethylolpropane tris(β-mercaptopropionate), pentaerythritol tetrakis(thioglycolate) and pentaerythritol tetrakis(3-mercaptopropionate), and mixtures thereof.

The polyene and the polythiol material together can be present in amounts of 1 to 25, such as 2 to 10 wt. %. The percentages by weight (i.e. wt. %) are based on total solid weight of the composition. The equivalent ratio of polyene to polythiol can be from 0.5 to 50:1, such as from 8 to 20:1, or 13 to 16:1. Any values within any of these ranges can be combined.

The compositions described herein can also contain any number of other components that are standard in the art, particularly for compositions curable by radiation. For example, any number of mono (meth)acrylate, mono (meth)allyl and/or mono (meth)acrylamide compounds known in the art can be included in the composition.

In certain embodiments, the composition may further comprise (c) a Michael addition catalyst. A “Michael addition” means a thio-Michael addition in which a compound with —SH functionality adds to a double bond. Examples of suitable catalysts include primary, secondary and tertiary amines and quaternary ammonium compounds. Specific examples include isophorone diamine, butylamine, n-octylamine, n-nonylamine, N,N′-diethylamine-propyl-3-amine, aniline, dioctylamine, triethylamine and tetramethylguanidine. Also, blocked primary and secondary amines such as those mentioned above reacted with an aldehyde and/or a ketone to form an aldamine and/or a ketimine may be used. The amount of the Michael addition catalyst present in certain embodiments of the curable composition is typically from 0.001% to 5%, such as 0.05 to 0.3 percent by weight based on weight of the polyene and polythiol.

Other suitable additives include photoiniators, flow adds, rheology modifiers, antifoaming agents, wetting agents, waxes, lubricants, plasticizers, fortifiers, stabilizers, and/or catalysts. If used, these additives may be present in amounts up to 30 wt. %, such as up to 20 wt. %, up to 15 wt. % or up to 8 wt. % based on total solid weight of the composition.

Suitable photoiniators include, but are not limited to, those that absorb within the wavelength range of 190 to 600 nm. Examples of photoiniators for radiation systems are benzoin and benzoin derivatives, acetophenone, and acetophenone derivatives such as, for example, 2,2-diacetoxyacetophenone, benzophenone and benzophenone derivatives, thioxanthone and thioxanthone derivatives, anthraquinone, 1-benzoylcyclohexanol, organophosphorus compounds such as, for example, acyl phosphine oxides and α hydroxy ketones. The photoinitiators, when present, may be used in quantities of, for example, from 1 to 20 wt. %, such as 1 to 15, 6 to 9, or 8 wt. %, with wt. % based on solid weight of the composition.

The coatings of the present invention can also include a colorant. If colorants are used, the wt. % of additives in the composition can be up to 75 wt. %. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

The composition used according to the invention may also contain solvents and/or diluents such as organic solvents and/or water. In certain embodiments, the compositions are 100 percent solids or substantially 100 percent solids (i.e. 95 wt. % solids or greater, such as 98 wt. % solids or greater or 99 wt. % solids or greater). Examples of suitable organic solvents are mono- or polyhydric alcohols, such as ethylene glycol and butanol, and glycol ethers or esters, such as diethylene glycol dialkyl ethers containing a C₁ to C₆ alkyl. When present, the solvents and/or diluents can comprise up to 50 wt. % of the composition, based on total weight of the composition.

As noted above, the present invention is directed to a variety of different packages coated at least in part with any of the compositions described above. In certain embodiments, the package is a metal can. The term “metal can” includes any type of metal can, container or any type of receptacle or portion thereof used to hold something. One example of a metal can is a food can; the term “food can(s)” is used herein to refer to cans, containers or any type of receptacle or portion thereof used to hold any type of food and/or beverage. The term “metal can(s)” specifically includes “can ends”, which are typically stamped from can end stock and used in conjunction with the packaging of beverages. The term “metal cans” also specifically includes metal caps and/or closures such as bottle caps, screw top caps and lids of any size, lug caps, and the like. The metal cans can be used to hold other items as well, including but not limited to personal care products, bug spray, spray paint, and any other compound suitable for packaging in an aerosol can. The metal cans can be prepared from any metallic substrate, such as aluminum, steel, including tin-plated steel, tin-free steel and/or chromium passivated steel and the like. The cans can include “two-piece cans” and “three-piece cans” as well as draw and ironed one-piece cans; such one-piece cans often find application with aerosol products.

The coating can be applied to the interior and/or the exterior of the metal can. For example, the coating can be rollcoated on to the metal used to make a two-piece food can, a three-piece food can, can end stock or cap/closure stock. In some embodiments, the coating is applied to a coil or sheet by roll coating; the coating is then cured by radiation and can ends are stamped out and fabricated into the finished product, i.e. can ends. In other embodiments, the coating is applied as a rim coat to the bottom of the can; such application can be by roll coating. The rim coat functions to reduce friction for improved handling during the continued fabrication and/or processing of the can. In certain embodiments, the coating is applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans.

The coatings as described above can also be applied internally to packages according to the present invention, although such use would be particularly relevant for packages that did not contain food, beverage or personal care products.

The packages of the present invention can also comprise a polymeric substrate, such as polyester, polyolefin, polyamide, cellulosic, polystyrene, polyacrylic, polycarbonate, PET, poly(ethylene naphthalate), polypropylene, polyethylene, nylon, EVOH, polylactic acid, other “green” polymeric substrates and/or combinations thereof. Such substrates are generally used to make, without limitation, plastic bottles, plastic tubes, and flexible plastic substrates. Such substrates can be coated according to the present invention to impart a barrier to the substrate; that is, they are “barrier coatings”. “Barrier coating” refers to a coating having a low permeability to gases such as oxygen and/or carbon dioxide; that is, the coating exhibits resistance to the passage of oxygen, carbon dioxide and/or other gases through the material. Any resistance to permeation of any gas is sufficient to qualify the coating as a “barrier coating” according to the present invention. The coating described herein can also be used on polymeric substrate packages as a varnish and/or as an adhesive. For example, the coating can be used as an adhesive for a label and/or a subsequent coating layer. The coating described herein can further be used between two layers in a multi-layer laminate structure.

The packages of the present invention can be coated with any of the compositions described above by any means known in the art, such as spraying, rolling, dipping, brushing, flow coating and the like; the coating may also be applied by electrocoating when the substrate is conductive. The appropriate means of application can be determined by one skilled in the art based upon the type of package being coated and the type of function for which the coating is being used. The coatings described above can be applied over the substrate as a single layer or as multiple layers with multiple heating stages between the application of each layer, if desired.

After application to the substrate, the coating compositions may be cured by exposure to radiation. The radiation can be, for example, high-energy radiation or actinic radiation.

A class of high-energy bombardment includes energetic electrons such as those derived from isotopes such as strontium-90, or intense electron beams produced by particle accelerators. Electron beam curing may be most useful in applications where very rapid and economical rates are desired.

A class of actinic radiation useful herein is ultraviolet light and other forms of actinic radiation that are normally found in radiation emitted from the sun or from artificial sources such as, without limitation, Type RS Sunlamps, carbon arc lamps, gas discharge tubes, such as xenon arc lamps, mercury vapor lamps, tungsten halide lamps, pulsed and unpulsed TV lasers, UV spot radiators, such as UV-emitting diodes and black light tubes, electrodeless microwave powered lamps, and the like. Ultraviolet radiation may be used most efficiently if the polyene/polythiol composition contains a suitable photocuring rate accelerator. Curing periods may be adjusted to be very short and hence commercially economical by proper choice of ultraviolet source, photocuring rate accelerator and concentration thereof, temperature and molecular weight, and reactive group functionality of the polyene and polythiol.

Low-energy ultraviolet radiation falling within the 200-450 nanometer wavelength interval is particularly suitable, primarily for safety reasons. The ratio of UV-B content to UV-A content can be 1:1 or less. The dosage of a radiation can vary depending on the type of package and the needs of the user, but can range, for example, from 50 to 400 mJ/cm², 1000 mJ/cm² or 2000 mJ/cm².

Not wishing to be bound by any particular theory, for embodiments in which a Michael addition catalyst is used, it is believed that during the curing step, both a free radical addition reaction caused by the radiation and a Michael addition reaction is occurring. Thus, if for some reason the free radical addition reaction does not effect sufficient cure of the composition, the Michael addition reaction should.

The dry film thickness of the coating applied to the present packages can also vary based upon the needs of the user, but may typically range from 1 to 9 mg/in², such as 3 mg/in².

The present direction is further directed to a method for making a package, comprising applying to a packaging material a coating composition comprising a polyene and a polythiol, wherein the composition is curable by radiation. Any of the coating compositions described above can be used according to the present method. According to certain embodiments, the method can include application and cure of the composition to the packaging material before the packaging material is fabricated into a package, and in other embodiments the composition can be applied after at least a portion of the packaging material has been fabricated into the package. “Packaging material” as used herein refers to any of the substrates described above, including the polymeric substrates and the metallic substrates, and can refer to such material in any stage of fabrication of the package including the finished package.

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein. The word “including” is intended to be open-ended; that is, it should be read as including but not limited to, including without limitation and the like. Singular encompasses plural and vice versa. For example, although reference is made herein including the claims to “a” polyene, “a” polythiol, “a” (meth)acrylate, “a” thiol-containing acid, “a” Michael addition catalyst, and the like, one or more of each of these and any other components can be used. As used herein, the term “polymer” refers to oligomers and both homopolymers and copolymers, and the prefix “poly” refers to two or more.

### EXAMPLES

### Example 1

The following items were added to a mixing vessel and agitated at low to medium speed:

| INGREDIENT | % BY WT. |
|---|---|
| EBECRYL 3700¹ | 16.38 |
| SR 351² | 38.00 |
| LAROMER DPGDA³ | 28.00 |
| FIRSTCURE N-PAL⁴ | 0.05 |
| PHENOTHIAZINE⁵ | 0.02 |
| IRGACURE 651⁶ | 8.00 |
| EBECRYL 350⁷ | 0.50 |
| UVITEX OB⁸ | 0.10 |

¹Bisphenol A epoxy diacrylate, available from Cytec.
²Trimethylolpropane triacrylate, available from Sartomer.
³Dipropylene glycol diacrylate, available from BASF.
⁴Tris(N-nitroso-N-phenylhydroxyl), available from Albemarle.
⁵Thiophenylamine, available from Avecia.
⁶α,α-Dimethoxy-α-phenylacetophenone, available from Ciba-Giegy.
⁷Silicone ester acrylate oligomer, available from Cytec.
⁸Butylbenzoxazole, available from Ciba-Giegy.

The following components were added and dispersed at high speed with a Cowles blade for two hours:

| INGREDIENT | % BY WT. |
|---|---|
| LANCO TF 1778¹ | 1.00 |
| SHAMROCK S-379H² | 1.00 |

¹Polyethylene/Teflon wax, available from Lubrizol.
²Microcrystalline polyethylene wax, available from Shamrock.

A Hegman grind of 6¾ was achieved, at which time the following three components were added and mixed for an additional 30 minutes:

| INGREDIENT | % BY WT. |
|---|---|
| CD 9053¹ | 0.94 |
| THIOCURE PETMP LOW ODOR² | 5.81 |
| DY-SOLVE DV 2003³ | 0.20 |

¹Trifunctional acid ester, available from Sartomer.
²Pentaerythritol tetrakis(3-mercaptopropionate), available from Bruno Bock.
³Citrus derivative & petroleum distallates, available from Dyco-Tec.

### Example 2

The composition of Example 1 was applied to aluminum can bodies by drawdown using a Number 3 rod; the composition was cured with a medium pressure mercury vapor bulb at 150 mJ/cm² UVA measured with an EIT POWER PUCK. The following UV cure properties were obtained:

| UV CURE ONLY PROPERTIES | TYPICAL RESULT | METHOD |
|---|---|---|
| Cross hatch adhesion with 610 tape | 100% pass | ASTM D3359 |
| Altek COF @ 5 inches per minute | 0.05 | See below¹ |
| Sutherland rubs | No scratch or scuff | ASTM D5264 |
| 500 gms coating to coating | | |
| Steam retort 60′ @ 250° F. | 100% pass | See below² |
| Cross hatch adhesion with 610 tape | | |

¹The test uses Altek Company Model 9505A mobility tester equipped with a 4.4 lb. Sled with stainless steel ball bearings. The coated aluminum is placed on the tester with the coating side facing upward. The sled is placed on the coated aluminum with the ball bearings in contact with the coating. The sled speed is 5 inches per minute and the COF is recorded from the dial reading. The amount of force required to keep the sled moving at the indicated speed is recorded in the table above. A reading of 0.01 to 0.15 is typical of a coating suitable for use as a rim coat.
²The coated aluminum panel is placed in a Steris Eagle 10 sterilizer for 60 minutes @ 250° F. After 60 minutes, the sample is removed, wiped dry, and tested for adhesion using ASTM D3359.

Following UV cure, certain of the aluminum can bodies were post-baked for 3 minutes at 400° F. and further subjected to the following tests with the following results:

| POST BAKE 3′ @ 400° F. | TYPICAL RESULT | METHOD |
|---|---|---|
| Cross hatch adhesion with 610 tape | 100% pass | ASTM D3359 |
| Altek COF @ 5 inches per minute | 0.04 | See below¹ |
| 1% Joy pasteurization 10′ | 100% pass | See below² |
| Cross hatch adhesion with 610 tape | | |
| Steam retort 60′ @ 250 F. | 100% pass | See below³ |
| Cross hatch adhesion with 610 tape | | |

¹The test uses Altek Company Model 9505A mobility tester equipped with a 4.4 lb. Sled with stainless steel ball bearings. The coated aluminum is placed on the tester with the coating side facing upward. The sled is placed on the coated aluminum with the ball bearings in contact with the coating. The sled speed is 5 inches per minute and the COF is recorded from the dial reading. The amount of force required to keep the sled moving at the indicated speed is recorded in the table above. A reading of 0.01 to 0.15 is typical of a coating suitable for use as a rim coat.
²The coated aluminum panel is immersed in a 1% by weight solution of JOY detergent in water for 10 minutes @ 80-84° C. After 10 minutes the sample is removed, wiped dry, and tested for adhesion using ASTM D3359.
³The coated aluminum panel is placed in a Steris Eagle 10 sterilizer for 60 minutes @ 250° F. After 60 minutes, the sample is removed, wiped dry, and tested for adhesion using ASTM D3359.

As can be seen from the above, the coatings of the present invention gave excellent results.

What is claimed is:

1. A package coated at least in part with a composition comprising:
(a) a polyene and
(b) a polythiol,
wherein the composition is curable by radiation.

2. The package of claim 1, wherein the polyene comprises (meth)acrylate.

3. The package of claim 2, wherein the polyene comprises two or more (meth)acrylates.

4. The package of claim 1, wherein the polyene comprises (meth)allyl.

5. The package of claim 2, wherein the (meth)acrylate comprises urethane (meth)acrylate.

6. The package of claim 2, wherein the polyene further comprises (meth)allyl.

7. The package of claim 2, wherein the meth(acrylate) comprises epoxy(meth)acrylate.

8. The package of claim 2, wherein the meth(acrylate) comprises dipropylene glycol diacrylate.

9. The package of claim 1, wherein the polythiol comprises a thiol-containing acid.

10. The package of claim 9, wherein the thiol-containing acid comprises pentaerythritol tetrakis(3-mercaptopropionate).

11. The package of claim 1, wherein the composition further comprises a Michael addition catalyst.

12. The package of claim 1, wherein the package is a metal can.

13. The package of claim 12, wherein the can is a one-piece can.

14. The package of claim 12, wherein the can is a two-piece can.

15. The package of claim 12, wherein the can is a three-piece can.

16. The package of claim 12, wherein the metal can comprises can end stock.

17. The package of claim 12, wherein the metal can comprises cap and/or closure stock.

18. The package of claim 12, wherein the composition is applied to the exterior of the metal can.

19. The package of claim 12, wherein the composition is applied to the interior and/or exterior of the metal can.

20. The package of claim 1, wherein the package comprises a polymeric substrate.

21. The package of claim 20, wherein the polymeric substrate comprises PET.

22. The package of claim 20, wherein the polymeric substrate comprises polyolefin.

23. A method for making a package comprising:
a) coating a packaging material, at least in part, with a composition comprising
i) a polyene and
ii) a polythiol; and
b) exposing the composition to radiation.

24. The method of claim 23, wherein the radiation is applied at a dosage of 50 to 400 mJ/cm².

25. The method of claim 23, wherein the radiation is applied at a dosage of 2000 mJ/cm².

26. The method of claim 23, wherein the composition is applied by a roll coater.

27. The method of claim 23, wherein the dry film thickness of the coating is 1 to 8 mg/in².
